(19) United States
(12) Patent Application Publication
(10) Pub. No.: US 2005/0197058 A1
(43) Pub. Date: Sep. 8, 2005

(54) Hand-held electronic device and method for inputting users' instruction

(75) Inventor: Yu-Hu Yan, Taiping City (TW)

Correspondence Address: SNELL & WILMER;ONE ARIZONA CENTER, 400 EAST VAN BUREN, PHOENIX, AZ, 850040001, US

(73) Assignee: BENQ CORPORATION

(21) Appl. No.: 11/074,267

(22) Filed: Mar. 7, 2005

(30) Foreign Application Priority Data
Mar. 5, 2004 (TW) 93105858

(51) Int. Cl. H04H 1/00

(52) U.S. Cl. 455/3.01

(57) ABSTRACT

A hand-held electronic device and a method for inputting users' instruction are disclosed. The hand-held electronic device includes a sensing device and a detecting circuit. The sensing device includes a passive unit and a receiving space. The passive unit moves in the receiving space. When the hand-held electronic device is tilted to a first direction, the passive unit moves to a second direction corresponding to the first direction. The detecting circuit detects the movement of the passive unit and generates a signal to change the operating status of the hand-held electronic device.

### CROSS-REFERENCE TO RELATED APPLICATIONS

This Application claims the right of priority based on Taiwan Patent Application No. 093105858 filed on Mar. 5, 2004.

### FIELD OF INVENTION

The present invention generally relates to a hand-held electronic device and a method for inputting users' instruction. More particularly, the present invention relates to a hand-held mobile telecommunication device and a method for inputting users' instruction.

### BACKGROUND OF THE INVENTION

In recent years, hand-held electronic devices have become more popular than ever. In order to meet users' variety demands, different types or shapes of the hand-held electronic devices are introduced. The appearance of the hand-held electronic devices is fashionable and the built-in software is capable of supporting many peripheral devices. Many makers have invested actively in the game software development of hand-held electronic devices due to combined capabilities of the mobile telecommunication and games. However, the operating interface is still a problem to users.

Users usually input instructions to the hand-held electronic device through a keyboard. FIG. 1 shows a traditional mobile telecommunication device 10. A cursor (not shown) displayed on the screen 150 is controlled by the control button 120. Users can only input one instruction at a time by pushing the “up”, “down”, “left” or “right” buttons of the control button 120 to move a position of the cursor, and therefore, the instructions that can be inputted are limited. In addition, as to control the objects in the games installed in the mobile telecommunication device 10, users have no other choices but to push the control button 120 with their thumbs. As a result, the desired operation agility cannot be met when playing games.

Recently, additional functional items have become developed for addressing aforementioned drawbacks. For example, “horizontal display function” of the screen and “shooting button” for specific games are provided to enhance the entertainment of games. However, the advantage of the hand-held electronic device resides on its portability, and therefore, exquisite design is the trend. The traditional keyboard methodology can no longer satisfy a user's requirement of ease of use.

### SUMMARY OF THE INVENTION

One aspect of the present invention is that as a user tilts the hand-held electronic device to one direction, operating status of the hand-held electronic device is changed.

Another aspect of the present invention is that as a user tilts the hand-held electronic device to one direction, a cursor displayed on a screen or the statuses of games are changed.

The hand-held electronic device includes a screen, a sensing device and a detecting circuit. The sensing device includes a receiving space and a passive unit moving in the receiving space. As the hand-held electronic device is tilted to a first direction, the passive unit moves to a second direction in the receiving space. The detecting circuit is used to detect a position of the passive unit and generates a signal. A cursor displayed on the screen moves to a third direction corresponding to the signal.

The present invention also provides a method for inputting users' instruction to a hand-held electronic device. The hand-held electronic device includes a sensing device having a receiving space and a passive unit moving in the receiving space. The method includes:
(a) tilting the hand-held device to a first direction, and the passive unit, responsive to the first direction, moving to a second direction; and
(b) corresponding to a position of the passive unit, the sensing device generating a signal for executing users' instruction.

### BRIEF DESCRIPTION OF THE DRAWINGS

FIG. 1 is a hand-held electronic device of the prior art;

FIG. 2 is a side view of the hand-held electronic device of the present invention;

FIG. 3 is a side view of the sensing device of the hand-held electronic device of the present invention;

FIG. 4 is a top view of the detecting circuit of the hand-held electronic device of the present invention;

FIG. 5 illustrates the position of the hand-held electronic device, as the hand-held electronic device is operated;

FIG. 6 shows the position of the passive unit in the sensing device, as the hand-held electronic device is operated;

FIG. 7 is a side view of the sensing device of an embodiment of the present invention;

FIGS. 8A, 8B show the embodiments of the hand-held electronic device of an embodiment of the present invention; and

FIG. 9 is a flow chart of the input method of the hand-held electronic.

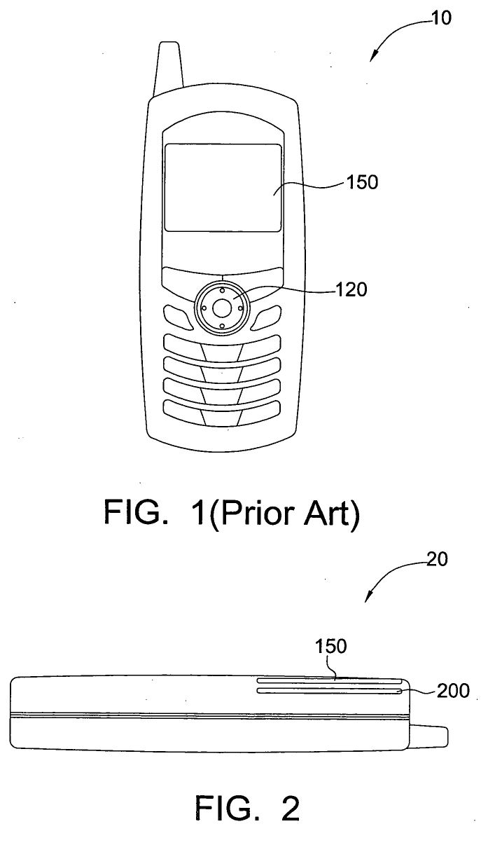

### DETAILED DESCRIPTION

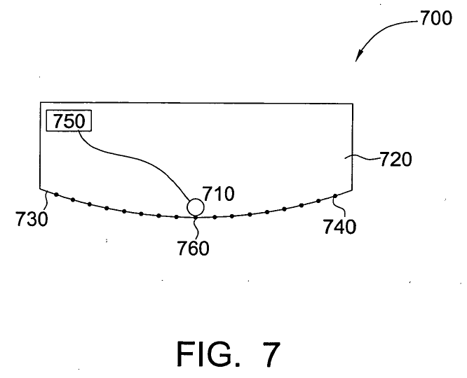

A hand-held electronic device of the present invention mentioned herein may be a mobile telecommunication device, a Personal Digital Assistant (PDA), a hand-held videogame or other resemblances. As FIG. 2 shows, the hand-held electronic device 20 includes a sensing device 200, a screen 150 and a detecting circuit (referring to FIG. 4 or FIG. 7). The size of the sensing device 200 is about equal to that of the screen 150.

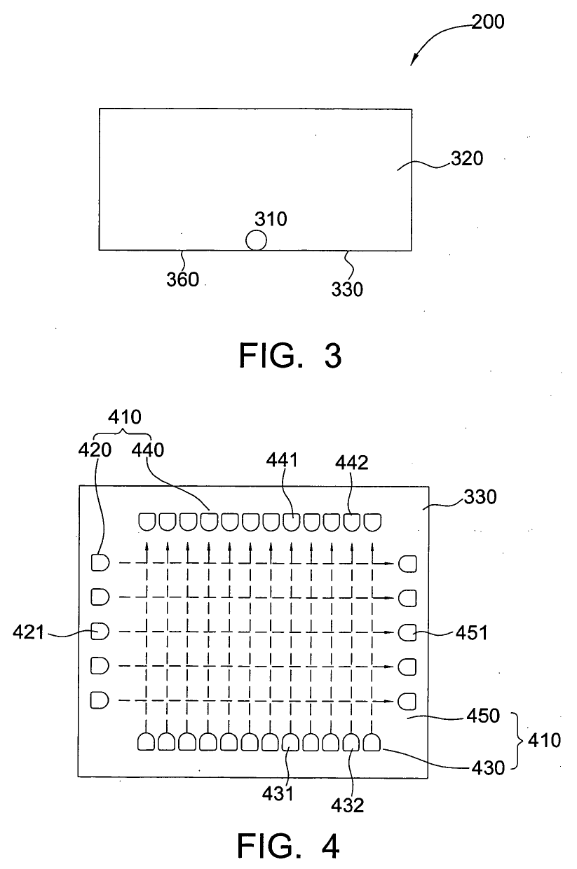

As FIG. 3 shows, the sensing device 200 includes a passive unit 310 and a receiving space 320. One embodiment of the passive unit 310 is a spheroid. The receiving space 320 defines a bottom surface 330 for the passive unit 310 to move thereon. The bottom surface 330 defines rectangular coordinates and has a default point 360. As the hand-held electronic device 20 (not shown) is held horizontally, the passive unit 310 moves to the default point 360. Another embodiment of the bottom surface 330 is bowl-shaped or a concave-shaped (not shown). As the hand-held electronic device is held horizontally, the passive unit moves to the lowest position of the bottom surface, i.e. the default point, and the passive unit is in a quiescent state.

As FIG. 4 shows, the detecting circuit 410 includes light sources 420 and 430, and receivers 440 and 450. The light sources 420 and 430 include a plurality of light elements, such as 421, 431 and 432. The receivers 440 and 450 include a plurality of receiving elements, such as 441, 442 and 451. One embodiment of the light sources 420 and 430 are light emitting diodes (LED) that emit parallel light beams. The light beams from the light sources 420 are orthogonal to those from the light sources 430 (shown as dotted lines). The receivers 440 and 450 receive the light beams from the light sources 430 and 420 respectively.

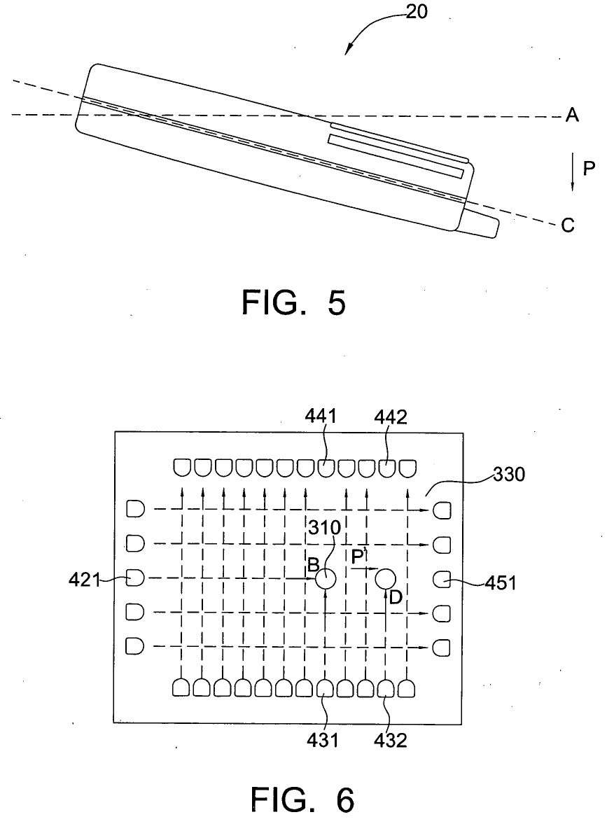

When the hand-held electronic device 20 is held horizontally, the hand-held electronic device 20 is at position A shown in FIG. 5. The passive unit 310 is at position B, i.e. the default point of FIG. 6, which corresponds to position A in FIG. 5. The passive unit 310 is as an opaque object, so that the receiving element 441 or 451 cannot receive the light beams from the light elements 431 or 421 respectively. Therefore, the position of the passive unit 310 can be detected. In addition, the bottom surface 330 defines the rectangular coordinates. As the information of the receiving elements 441 and 451 detect the passive unit 310, the rectangular coordinates (X1, Y1) (not shown) of the passive unit 310 is obtained.

When the hand-held electronic device 20 is tilted along a first direction (arrow P) in FIG. 5, from position A to position C, the passive unit 310 on the bottom surface 330 in FIG. 6, moves along a second direction (arrow P′), from position B to position D. As the passive unit 310 is at position D, the receiving elements 442 and 451 cannot receive the light beams from the light elements 432 and 421, and the passive unit 310 is detected accordingly, and the rectangular coordinates (X2, Y2) of the passive unit 310 is obtained. The second direction (arrow P′) shown in FIG. 6 corresponds to the first direction (arrow P) shown in FIG. 5.

Another embodiment of the sensing device is disclosed in FIG. 7. The sensing device 700 includes a passive unit 710 and a receiving space 720. The receiving space 720 defines a bottom surface 730 having a plurality of contact points 740 and a default point 760 thereon. One embodiment of the passive unit 710 is a spheroid, and the passive unit 710 moves on the bottom surface 730. The passive unit 710 and each contact point 740 have an electrical potential difference therebetween. A detecting circuit 750 is electrically connected to the passive unit 710. The detecting circuit 750 generates a signal corresponding to a movement vector of the passive unit 710. The bottom surface 730 includes, but is not limited to, bowl-shape. As the hand-held electronic device is held horizontally, the passive unit is at the lowest position of the bottom surface, i.e. the default point 760 at which the passive unit 710 is in a quiescent state.

As users desire to change an operating status of the hand-held electronic device, such as the cursor displayed on the screen or the objects in the game, users only need to tilt the hand-held electronic device. When the hand-held electronic device is tilted, the passive unit 710 moving on the bottom surface 730 contacts one of the contact points 740, as shown in FIG. 7. The passive unit 710 has an electrical potential, and the contact points 740 are connected to the ground, so that the passive unit 710 and each contact point 740 have an electrical potential difference therebetween. As the passive unit 710 contacts any one of the contact points 740, the electrical potential of the passive unit 710 changes. As a result, the detecting circuit 750 electrically connecting to the passive unit 710 detects the position of the passive unit 710 during its movement, and then the movement vector of the passive unit 710 is computed.

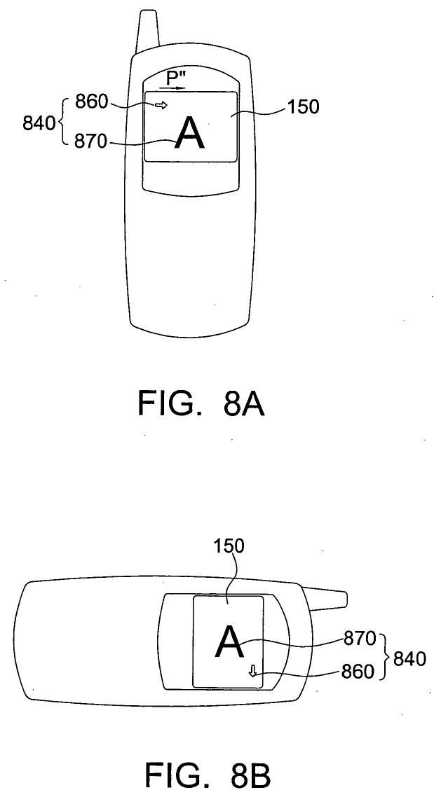

In one embodiment of the present invention, as the passive unit is detected, the detecting circuit 750 generates a signal. Referring to FIGS. 8A and 8B, the signal 840 makes changes of including, but is not limited to, texts or an image, such as change of a cursor 860 or an image 870 displayed on the screen. As the hand-held electronic device is tilted, the cursor 860 displayed on the screen 150 (FIG. 8A) moves along a third direction (arrow P″), causing the cursor 860 or the image 870 to change orientation or location. The third direction (arrow P″) corresponds to the second direction (arrow P′). Therefore, users can change texts or the image on the screen according to their needs. In addition, when users want to change orientation or location of an image in a game, he or she only has to tilt the hand-held electronic device to one direction. For example, in a computer fishing game, users may tilt the hand-held electronic device resulting in change of the position of the fisher or the operation of the fishing rod.

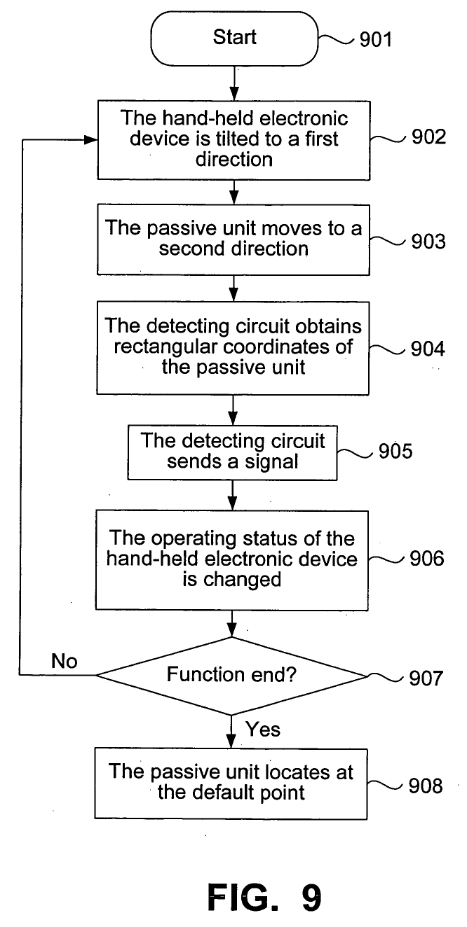

FIG. 9 discloses a flow chart for inputting user's instructions of the present invention. The hand-held electronic device includes a screen, a sensing device and a detecting circuit. The sensing device has a passive unit and a receiving space. The receiving space includes a bottom surface. Referring to FIG. 9, the process starts at step 901. As users tilt the hand-held electronic device to a first direction (step 902), the passive unit on the bottom surface moves to a second direction (step 903), and the detecting circuit obtains the rectangular coordinates of the passive unit (step 904). The movement vector of the passive unit is computed, and then the detecting circuit sends a signal (step 905) causing the operating status of the hand-held electronic device to change (step 906). If the purpose of changing the operating status of the hand-held electronic device is achieved (step 907), the passive unit will be quiescent and located at the default point of the bottom surface (step 908). If the purpose is not completed (step 907), steps 902 to 906 will be repeated.

In one embodiment of the present invention, the detecting circuit includes light sources and receivers. In step 904, the receivers are used to receive the light beams from the light sources. The passive unit is an opaque object. As the hand-held electronic device is tilted to a first direction (step 902), the passive unit on bottom surface moves to a second direction (step 903). Therefore, the detecting circuit detects the passive unit, obtains the rectangular coordinate of the passive unit, and then the movement vector of the passive unit is computed.

In another embodiment of the present invention, the passive unit and contact points on the bottom surface have an electrical potential difference therebetween. As the hand-held electronic device is tilted to a first direction (step 902), the passive unit on the bottom surface moves to a second direction (step 903). As the passive unit moves and contacts one of the contact points, the electrical potential of the passive unit alternatively changes due to an electrical connection between the passive unit and the contact point. Therefore, the detecting circuit, which is electrically connected to the passive unit, detects the position of the passive unit, obtains the rectangular coordinates of the passive unit, and then the movement vector of the passive unit is computed.

In step 906, the change of operating status of the hand-held electronic device includes generating an image or change the position of the cursor. Referring to FIGS. 8A and 8B, as the hand-held electronic device is tilted, the orientation of the image (i.e. “A”) displayed on the screen 150 is changed. Thereby, users can change orientation or location of texts or the image on the screen according to their needs.

As the process is completed (in step 907), the passive unit is at the lowest of the bottom surface, i.e. default point, in step 908.

By means of the detailed descriptions of what is presently considered to be the most practical and preferred embodiments of the subject invention, it is the expectation that the features and the gist thereof are plainly revealed. Nevertheless, these above-mentioned illustrations are not intended to be construed in a limiting sense. Instead, it should be well understood that any analogous variation and equivalent arrangement is supposed to be covered within the spirit and scope to be protected and that the interpretation of the scope of the subject invention would therefore as much as broadly apply.

1. A hand-held electronic device comprising:
a sensing device, comprising a passive unit and a receiving space, and the passive unit moving in the receiving space, wherein as the hand-held electronic device is tilted to a first direction, the passive unit, responsive to the first direction, moves to a second direction; and
a detecting circuit for detecting movement of the passive unit and generating a signal to change an operating status of the hand-held electronic device.

2. The hand-held electronic device of claim 1 further comprising a screen, wherein an image corresponding to the signal is displayed on the screen.

3. The hand-held electronic device of claim 2, wherein a cursor displayed on the screen moves to a third direction corresponding to the signal.

4. The hand-held electronic device of claim 1, wherein the receiving space defines a contact point, and as the passive unit moves to the second direction and contacts the contact point, the detecting circuit generates the signal.

5. The hand-held electronic device of claim 4, wherein the passive unit and the contact point have an electrical potential difference therebetween, and as the passive unit contacts the contact point, the detecting circuit generates the signal due to a variation of electrical potential of the passive unit.

6. The hand-held electronic device of claim 1, wherein the detecting circuit comprises:
a light source for generating light beams; and
a receiver for selectively receiving the light beams;
wherein as the passive unit moves to the second direction, the detecting circuit generates the signal corresponding to the position of the passive unit.

7. The hand-held electronic device of claim 1, wherein the passive unit is a spheroid.

8. The hand-held electronic device of claim 1, wherein the receiving space defines a bottom surface, and the passive unit moves on the bottom surface.

9. The hand-held electronic device of claim 8, wherein the bottom surface has a default point, and as the hand-held electronic device is held horizontally, the passive unit moves to the default point.

10. The hand-held electronic device of claim 8, wherein the bottom surface is concave-shape.

11. The hand-held electronic device of claim 8, wherein the bottom surface is a plane.

12. The hand-held electronic device of claim 1, wherein the bottom surface defines rectangular coordinates, and the signal includes information of coordinates of the passive unit in the receiving space.

13. The hand-held electronic device of claim 1, wherein the signal comprises a movement vector of the passive unit.

14. A method for inputting users' instruction to a hand-held electronic devices, the hand-held electronic device having a sensing device, including a receiving space and a passive unit, and the passive unit moving in the receiving space, the method comprising:
(a) tilting the hand-held device to a first direction, and the passive unit, responsive to the first direction, moving to a second direction; and
(b) corresponding to a position of the passive unit, the sensing device generating a signal for executing users' instruction.

15. The input method of the claim 14, wherein the receiving space defines a contact point, and as the passive unit moves to the second direction and contacts the contact point, the signal is generated.

16. The input method of the claim 15, wherein the sensing device comprises a light source for generating light beams and a receiver for selectively receiving the light beams, and as the passive unit moves to the second direction in the receiving space, the signal is generated.

17. The input method of the claim 14, wherein the hand-held electronic device comprises a screen, the input method further comprising:
(c) generating an image, corresponding to the signal, on the screen.

18. The input method of the claim 17, wherein the screen is used to display a cursor, the input method further comprising:
(d) the cursor, corresponding to the signal, moving to a third direction.

19. The input method of the claim 14, wherein the passive unit moves to a default point of the receiving space selectively after the signal is generated.
